(19) United States
(12) Patent Application Publication
(10) Pub. No.: US 2025/0341431 A1
(43) Pub. Date: Nov. 6, 2025

(54) TEMPERATURE SENSING CABLE, FIRE ALARM METHOD AND FIRE ALARM SYSTEM

(71) Applicants: BEIJING JADE BIRD UNIVERSAL FIRE PROTECTION SYSTEM SOFTWARE SERVICE CO., LTD., Beijing (CN); Jade Bird Fire Co., Ltd., Hebei (CN)

(72) Inventors: Youliang XIE, Hebei (CN); Chaoping LIU, Hebei (CN); Zhihua YANG, Hebei (CN); Ying GAO, Hebei (CN)

(21) Appl. No.: 19/084,220

(22) Filed: Mar. 19, 2025

(30) Foreign Application Priority Data
May 6, 2024 (CN) 2024105509933

(51) Int. Cl. G01K 7/24; G01K 1/14; G08B 17/06

(52) U.S. Cl. CPC G01K 7/24; G01K 1/14; G08B 17/06

(57) ABSTRACT

The present disclosure provides a temperature sensing cable, wherein a controller in a temperature-sensing control unit can sense the change in temperature nearby via a first temperature acquisition circuit and a second temperature acquisition circuit, and output an early warning signal to provide a high temperature warning (or fire warning). The early warning signal may carry the address information of the controller. By determining the position of the controller that sends out the early warning signal, the high temperature point (or firing point) can be accurately located. The present disclosure further provides a fire alarm method and a fire alarm system, which are implemented based on the above-mentioned temperature sensing cable. By performing a comprehensive judgment on the temperature field data information of multiple relevant temperature-sensing control units, false alarms can be reduced, especially false alarms caused by factors such as electromagnetic interference, humid environment, construction extrusion, and local rapid temperature rise.

### TECHNICAL FIELD

The present disclosure generally relates to the field of fire protection technology, and in particular to a temperature sensing cable, a fire alarm method, and a fire alarm system.

### BACKGROUND

A temperature sensing cable, also known as a linear temperature-sensing fire detector, is a fire detector that responds to the temperature around a certain continuous line. Temperature sensing cables are divided into two types: recoverable and irrecoverable. Among them, the irrecoverable temperature sensing cable consists of two conductors insulated with a thermosensitive material. When the ambient temperature rises to a predetermined action temperature, the temperature sensitive material may adhere, causing short circuit between the two conductors, thereby generating an alarm signal. The recoverable temperature sensing cable, also known as an analog-quantity temperature sensing cable, has a resistance that changes with a temperature. When the change in the resistance reaches a set alarm threshold, the detector sends out an alarm signal. Although these temperature sensing cables each can be used to monitor the operating temperature of a power cable, and send out an alarm signal when the temperature at a certain segment on the power cable is too high, none of them can be relied on to accurately locate the high-temperature segment. In addition, these temperature sensing cables generally have the poor performances of moisture resistance and anti-electromagnetic interference. When these temperature sensing cables are used to monitor power cables, they often cause false alarms due to electromagnetic interference and/or moisture (the power cables are usually arranged in places with high electromagnetic interference and/or humidity).

The content of the background section is only the technology known to the inventor and does not necessarily represent the prior art in the art.

### SUMMARY

In view of one ore more disadvantages in the prior art, the present disclosure provides a temperature sensing cable, including:
a power signal multiplexing cable;
a plurality of temperature sensing lines arranged at an interval along a length direction of the power signal multiplexing cable, the temperature sensing line comprising a first wire, a second wire and a temperature-sensing material, the temperature-sensing material being connected between the first wire and the second wire, the temperature-sensing material being a conductor, and a resistance value of the temperature-sensing material varying with a temperature; and
a plurality of temperature-sensing control units, the temperature-sensing control unit comprising a controller and a first temperature acquisition circuit, the plurality of temperature-sensing control units each being electrically connected between adjacent temperature sensing lines, and adjacent temperature-sensing control units and a temperature sensing line between the adjacent temperature-sensing control units forming a second temperature acquisition circuit, wherein the controller is coupled to the power signal multiplexing cable, the first temperature acquisition circuit and the second temperature acquisition circuit, respectively, the controller is configured to receive and/or send a signal via the power signal multiplexing cable, and the controller is configured to output an early warning signal according to a first analog quantity of the first temperature acquisition circuit and/or a second analog quantity of the second temperature acquisition circuit, and wherein both the first analog quantity and the second analog quantity vary with the temperature.

According to an aspect of the present disclosure, the controller is configured to:
output the early warning signal when the first analog quantity reaches a first warning threshold and the second analog quantity is in a first warning interval; and/or
output the early warning signal when a rate of change of the first analog quantity reaches a second warning threshold and a rate of change of the second analog quantity is in a second warning interval; and/or
output the early warning signal when the rate of change of the second analog quantity reaches a third warning threshold.

According to an aspect of the present disclosure, the first temperature acquisition circuit comprises a first resistor and a second resistor connected in series, and wherein the first resistor is a thermistor, and an acquisition node is provided between the first resistor and the second resistor; and
the controller comprises a power port and a first acquisition port, wherein the first temperature acquisition circuit is coupled between the power port and a ground, the first acquisition port is coupled to the acquisition node, and the controller is configured to acquire a first voltage signal via the first acquisition port and take the first voltage signal as the first analog quantity.

According to an aspect of the present disclosure, the temperature-sensing control unit further comprises a third resistor, a fourth resistor, a fifth resistor and a differential circuit, and wherein the third resistor is coupled between an upstream end of the first wire and an upstream end of the second wire, the fourth resistor is coupled between the power port and a downstream end of the first wire, the fifth resistor is coupled between a downstream end of the second wire and the ground, and the differential circuit has two input terminals, one of which is coupled to the downstream end of the first wire and the other of which is coupled to the downstream end of the second wire; and
the controller is configured to receive an output signal of the differential circuit and take it as the second analog quantity.

According to an aspect of the present disclosure, the differential circuit is integrated in the controller.

According to an aspect of the present disclosure, the temperature-sensing control unit further comprises a voltage-stabilizing capacitor, one electrode of which is grounded and the other electrode of which is coupled to the power port.

According to an aspect of the present disclosure, the power signal multiplexing cable comprises a third wire and a fourth wire;
the controller comprises a power-supply port and a data port; and
the temperature-sensing control unit comprises a first filter circuit, which is coupled to the third wire, the power-supply port and the data port, respectively, and the first filter circuit is configured to cooperate with the power signal multiplexing cable to provide a stable power supply and a signal that has been limited in amplitude and width, for the controller.

According to an aspect of the present disclosure, the first filter circuit comprises a sixth resistor, a filter capacitor and a noise-reduction discharge device, wherein the sixth resistor is connected between the third wire and the power-supply port; one electrode of the filter capacitor is grounded, and the other electrode of the filter capacitor is coupled between the sixth resistor and the power-supply port; and the noise-reduction discharge device has a built-in spike discharge circuit, and is connected between the third wire and the data port.

According to an aspect of the present disclosure, the temperature-sensing control unit further comprises a first diode, which is connected between the third wire and the first filter circuit and is configured to allow a current to flow from the third wire to the first filter circuit.

According to an aspect of the present disclosure, the controller has a built-in second filter circuit, which is coupled to the data port and is configured to filter out an interference signal.

According to an aspect of the present disclosure, the temperature sensing cable further comprises an insulating layer, the power signal multiplexing cable and the temperature sensing lines are embedded in the insulating layer, a plurality of mounting holes are provided on the insulating layer, and the temperature-sensing control units are provided in the mounting holes; and an insulating protective layer is sleeved on outside of the insulating layer, and is arranged along an entire length of the temperature sensing cable.

The present disclosure further provides a fire alarm method, based on the temperature sensing cable described above, the fire alarm method including:
determining a plurality of relevant temperature-sensing control units according to the early warning signal;
acquiring temperature field data information of each of the relevant temperature-sensing control units, the temperature field data information comprising a first analog quantity, a rate of change of the first analog quantity, a second analog quantity, and a rate of change of the second analog quantity; and
determining whether to perform a fire alarm according to the temperature field data information of the plurality of relevant temperature-sensing control units.

According to an aspect of the present disclosure, the determining a plurality of relevant temperature-sensing control units according to the early warning signal comprises:
determining a temperature-sensing control unit that sends out the early warning signal, according to the early warning signal; and
taking the temperature-sensing control unit that sends out the early warning signal and a plurality of temperature-sensing control units in its vicinity as the relevant temperature-sensing control units.

According to an aspect of the present disclosure, the determining whether to perform a fire alarm according to the temperature field data information of the plurality of relevant temperature-sensing control units comprises:
determining a first factor according to the first analog quantities of the plurality of relevant temperature-sensing control units;
determining a second factor according to the rates of change of the first analog quantities of the plurality of relevant temperature-sensing control units;
determining a third factor according to the second analog quantities of the plurality of relevant temperature-sensing control units;
determining a fourth factor according to the rates of change of the second analog quantities of the plurality of relevant temperature-sensing control units;
performing weighted fusion on the first factor, the second factor, the third factor and the fourth factor according to a preset weight coefficient of the first factor, a preset weight coefficient of the second factor, a preset weight coefficient of the third factor and a preset weight coefficient of the fourth factor, to obtain a fifth factor;
if the fifth factor is greater than an alarm threshold, performing a fire alarm; and
otherwise, performing no fire alarm.

According to an aspect of the present disclosure, the first factor A is determined according to the following formula:

$$A = {Σ}_{i = 2}^{n} \vert ( {M}_{i} {R}_{1} - {M}_{i - 1} {R}_{1} ) \vert ;$$

where n is a number of the relevant temperature-sensing control units, MᵢR₁ is the first analog quantity of an i-th relevant temperature-sensing control unit among the plurality of relevant temperature-sensing control units, and Mᵢ₋₁R₁ is the first analog quantity of an (i−1)th relevant temperature-sensing control unit among the plurality of relevant temperature-sensing control units.

According to an aspect of the present disclosure, the second factor is a number of ones exceeding a preset threshold among the rates of change of the first analog quantities of the relevant temperature-sensing control units.

According to an aspect of the present disclosure, the third factor C is determined according to the following formula:

$$C = {Σ}_{i = 2}^{n} \vert ( {M}_{i} {R}_{1} - {M}_{i - 1} {R}_{a} ) \vert / {M}_{n} ;$$

where n is a number of the relevant temperature-sensing control units, MᵢRₐ is the second analog quantity of an i-th relevant temperature-sensing control unit among the plurality of relevant temperature-sensing control units, Mᵢ₋₁Rₐ is the second analog quantity of an (i−1)th relevant temperature-sensing control unit among the plurality of relevant temperature-sensing control units, and Mₙ is an environmental reference value.

According to an aspect of the present disclosure, the fourth factor D is determined according to the following formula:

$$D = {Σ}_{i = 1}^{n} {M}_{i} {R}_{a} / T ;$$

where n is a number of the relevant temperature-sensing control units, and MᵢRₐ/T is the rate of change of the second analog quantity of an i-th relevant temperature-sensing control unit among the plurality of relevant temperature-sensing control units.

The present disclosure further provides a fire alarm system, including:
the temperature sensing cable described above;
a terminal box connected to a tail end of the temperature sensing cable; and
a signal processing unit connected to a front end of the temperature sensing cable and configured to:
determine a plurality of relevant temperature-sensing control units according to the early warning signal;
acquire temperature field data information of each of the relevant temperature-sensing control units, the temperature field data information comprising a first analog quantity, a rate of change of the first analog quantity, a second analog quantity, and a rate of change of the second analog quantity; and
determine whether to perform a fire alarm according to the temperature field data information of the plurality of relevant temperature-sensing control units.

According to an aspect of the present disclosure, the signal processing unit is configured to:
determine a temperature-sensing control unit that sends out the early warning signal, according to the early warning signal; and
take the temperature-sensing control unit that sends out the early warning signal and a plurality of temperature-sensing control units in its vicinity as the relevant temperature-sensing control units.

According to an aspect of the present disclosure, the signal processing unit is configured to:
determine a first factor according to the first analog quantities of the plurality of relevant temperature-sensing control units;
determine a second factor according to the rates of change of the first analog quantities of the plurality of relevant temperature-sensing control units;
determine a third factor according to the second analog quantities of the plurality of relevant temperature-sensing control units;
determine a fourth factor according to the rates of change of the second analog quantities of the plurality of relevant temperature-sensing control units;
perform weighted fusion on the first factor, the second factor, the third factor and the fourth factor according to a preset weight coefficient of the first factor, a preset weight coefficient of the second factor, a preset weight coefficient of the third factor and a preset weight coefficient of the fourth factor, to obtain a fifth factor;
if the fifth factor is greater than an alarm threshold, perform a fire alarm; and
otherwise, perform no fire alarm.

According to an aspect of the present disclosure, the signal processing unit is configured to: determine the first factor A according to the following formula:

$$A = {\sum }_{i = 2}^{n} \vert ( {M}_{i} {R}_{1} - {M}_{i - 1} {R}_{1} ) \vert ;$$

where n is a number of the relevant temperature-sensing control units, MᵢR₁ is the first analog quantity of an i-th relevant temperature-sensing control unit among the plurality of relevant temperature-sensing control units, and Mᵢ₋₁R₁ is the first analog quantity of an (i−1)th relevant temperature-sensing control unit among the plurality of relevant temperature-sensing control units.

According to an aspect of the present disclosure, the second factor is a number of ones exceeding a preset threshold among the rates of change of the first analog quantities of the relevant temperature-sensing control units.

According to an aspect of the present disclosure, the signal processing unit is configured to determine the third factor C according to the following formula:

$$C = {\sum }_{i = 2}^{n} \vert ( {M}_{i} {R}_{a} - {M}_{i - 1} {R}_{a} ) \vert / {M}_{n} ;$$

where n is a number of the relevant temperature-sensing control units, MᵢRₐ is the second analog quantity of an i-th relevant temperature-sensing control unit among the plurality of relevant temperature-sensing control units, Mᵢ₋₁Rₐ is the second analog quantity of an (i−1)th relevant temperature-sensing control unit among the plurality of relevant temperature-sensing control units, and Mₙ is an environmental reference value.

According to an aspect of the present disclosure, the signal processing unit is configured to determine the fourth factor D according to the following formula:

$$D = {\sum }_{i = 1}^{n} {M}_{i} {R}_{a} / T ;$$

where n is a number of the relevant temperature-sensing control units, and MᵢRₐ/T is the rate of change of the second analog quantity of an i-th relevant temperature-sensing control unit among the plurality of relevant temperature-sensing control units.

Compared with the prior art, the embodiment of the present disclosure provides a temperature sensing cable, wherein a controller in a temperature-sensing control unit can sense the change in the temperature nearby through a first temperature acquisition circuit and a second temperature acquisition circuit, and output an early warning signal to provide a high temperature warning (or fire warning). The early warning signal can carry address information of the controller. By determining the position of the controller that sends out the early warning signal, the high temperature point (or firing point) can be accurately located. A first filtering circuit and a power signal multiplexing cable can provide a stable power supply and an amplitude-limited and width-limited signal for the controller, and the controller has a built-in second filtering circuit, which can filter out an interference signal, thereby improving the anti-electromagnetic interference performance of the temperature sensing cable. By embedding the power signal multiplexing cable and the temperature sensing lines into an insulation layer, arranging the temperature-sensing control units in mounting holes on the insulation layer and covering the mounting holes with an insulating protective layer, the moisture-proof performance of the temperature sensing cable can be improved.

The embodiments of the present disclosure further provide a fire alarm method and a fire alarm system, which are implemented based on the above-mentioned temperature sensing cable. By performing a comprehensive judgment on the temperature field data information of multiple relevant temperature-sensing control units, false alarms can be reduced, especially false alarms caused by factors such as electromagnetic interference, humid environment, construction extrusion, local rapid temperature rise.

### BRIEF DESCRIPTION OF THE DRAWINGS

The drawings, which provide further understanding of the present disclosure and constitute part of the specification, are used together with the embodiments of the present disclosure to explain the present disclosure and do not constitute a limitation on the present disclosure. In the drawings:

FIG. 1 shows a principle diagram of a temperature sensing cable according to an embodiment of the present disclosure;

FIG. 2 shows an enlarged view of a portion of FIG. 1;

FIG. 3 shows a schematic diagram of a temperature sensing cable according to an embodiment of the present disclosure;

FIG. 4 shows a flow chart of a fire alarm method according to an embodiment of the present disclosure; and

FIG. 5 shows a schematic diagram of a fire alarm system according to an embodiment of the present disclosure.

### DETAILED DESCRIPTION

In the following, only some exemplary embodiments are briefly described. As a person skilled in the art can realize, the described embodiments may be modified in various different ways without departing from the spirit or scope of the present disclosure. Accordingly, the drawings and descriptions are to be regarded as illustrative and not restrictive in nature.

In the description of the present disclosure, it needs to be understood that the orientation or position relations denoted by such terms as “central” “longitudinal” “latitudinal” “length” “width” “thickness” “above” “below” “front” “rear” “left” “right” “vertical” “horizontal” “top” “bottom” “inside” “outside” “clockwise” “counterclockwise” and the like are based on the orientation or position relations as shown in the drawings, and are used only for the purpose of facilitating description of the present disclosure and simplification of the description, instead of indicating or suggesting that the denoted devices or elements must be oriented specifically, or configured or operated in a specific orientation. Thus, such terms should not be construed to limit the present disclosure. In addition, such terms as “first” and “second” are only used for the purpose of description, rather than indicating or suggesting relative importance or implicitly indicating the number of the denoted technical features. Accordingly, features defined with “first” and “second” may, expressly or implicitly, include one or more of the features. In the description of the present disclosure, “plurality” means two or more, unless otherwise defined explicitly and specifically.

In the description of the present disclosure, it needs to be noted that, unless otherwise specified and defined explicitly, such terms as “installation” “coupling” and “connection” should be broadly understood as, for example, fixed connection, detachable connection, or integral connection; or mechanical connection, electrical connection or intercommunication; or direct connection, or indirect connection via an intermediary medium; or internal communication between two elements or interaction between two elements. For those skilled in the art, the specific meanings of such terms herein can be construed in light of the specific circumstances.

Herein, unless otherwise specified and defined explicitly, if a first feature is “on” or “beneath” a second feature, this may cover direct contact between the first and second features, or contact via another feature therebetween, other than the direct contact. Furthermore, if a first feature is “on”, “above”, or “over” a second feature, this may cover the case that the first feature is right above or obliquely above the second feature, or just indicate that the level of the first feature is higher than that of the second feature. If a first feature is “beneath”, “below”, or “under” a second feature, this may cover the case that the first feature is right below or obliquely below the second feature, or just indicate that the level of the first feature is lower than that of the second feature.

The following disclosure provides various different embodiments or examples so as to realize different structures described herein. In order to simplify the disclosure herein, the following will give the description of the parts and arrangements embodied in specific examples. Of course, they are only for the exemplary purpose, not intended to limit the present disclosure. Besides, the present disclosure may repeat a reference number and/or reference letter in different examples, and such repeat is for the purpose of simplification and clarity, which does not represent any relation among various embodiments and/or arrangements as discussed. In addition, the present disclosure provides examples of various specific processes and materials, but those skilled in the art can also be aware of application of other processes and/or use of other materials.

The preferred embodiments of the present disclosure are described below in conjunction with the drawings. It should be understood that the preferred embodiments described herein are only used to illustrate and explain the present disclosure and are not used to limit the present disclosure.

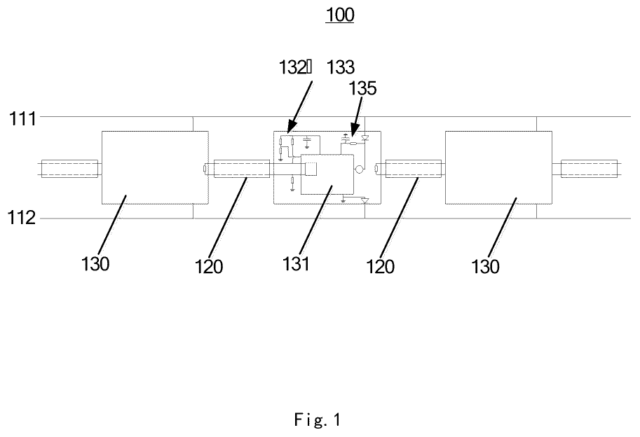

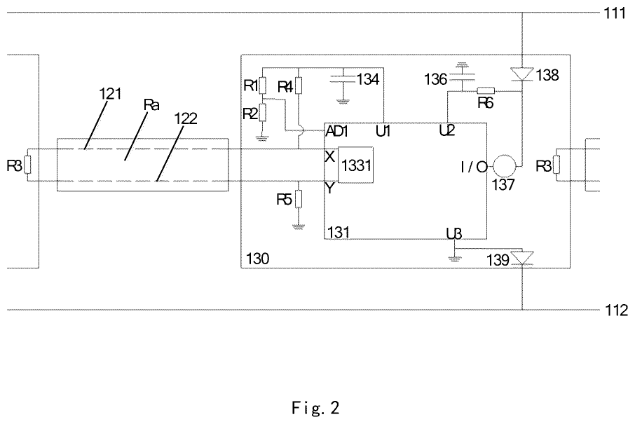

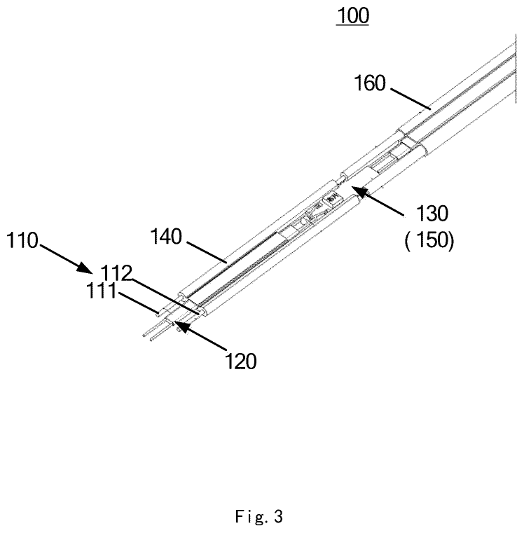

FIG. 1 shows a principle diagram of a temperature sensing cable 100 according to an embodiment of the present disclosure, FIG. 2 shows an enlarged view of a portion of FIG. 1, and FIG. 3 shows a schematic diagram of a temperature sensing cable 100 according to an embodiment of the present disclosure. The following is a detailed description in conjunction with FIGS. 1 to 3.

As shown in FIGS. 1 to 3, the temperature sensing cable 100 includes a power signal multiplexing cable 110, temperature sensing lines 120 and temperature-sensing control units 130, wherein the power signal multiplexing cable 110 extends in a first direction and can be used to provide power supply and data communication for the temperature-sensing control units 130. There are multiple temperature sensing lines 120 and multiple temperature-sensing control units 130, respectively. The multiple temperature sensing lines 120 are arranged at an interval along a length direction of the power signal multiplexing cable 110, and the multiple temperature-sensing control units 130 each are electrically connected between adjacent temperature sensing lines 120. That is, the temperature sensing lines 120 and the multiple temperature-sensing control units 130 are alternately arranged in sequence and connected to each other in the length direction of the power signal multiplexing cable 110. The temperature sensing line 120 includes a first wire 121, a second wire 122 and a temperature-sensing material Ra, wherein the temperature-sensing material Ra is connected between the first wire 121 and the second wire 122. The temperature-sensing material Ra is a conductor, and its resistance value varies with the change of temperature (for example, the higher the temperature, the smaller the resistance value of the temperature-sensing material Ra). The temperature-sensing control unit 130 includes a controller 131 and a first temperature acquisition circuit 132. In addition, adjacent temperature-sensing control units 130 and a temperature sensing line 120 located therebetween form a second temperature acquisition circuit 133. The first temperature acquisition circuit 132 and the second temperature acquisition circuit 133 can both accurately monitor the change of the ambient temperature. Specifically, the controller 131 is coupled to the power signal multiplexing cable 110, the first temperature acquisition circuit 132, and the second temperature acquisition circuit 133, respectively. The controller 131 is configured to receive and send signals via the power signal multiplexing cable 110. The controller 131 is also configured to obtain a first analog quantity from the first temperature acquisition circuit 132 and a second analog quantity from the second temperature acquisition circuit 133. The controller 131 is further configured to output an early warning signal according to the first analog quantity and/or the second analog quantity, wherein both the first analog quantity and the second analog quantity vary with the temperature. Therefore, the early warning signal can accurately reflect the temperature anomaly. By tracing the source of the early warning signal, the high temperature point or potential firing point can be accurately found.

According to one embodiment of the present disclosure, as shown in FIGS. 1 and 2, the controller 131 can be configured to output the early warning signal when the first analog quantity reaches a first warning threshold and the second analog quantity is in a first warning interval. The controller 131 can also be configured to output the early warning signal when the rate of change of the first analog quantity reaches a second warning threshold and the rate of change of the second analog quantity is in a second warning interval. The rate of change of the first analog quantity is defined as the change amount of the first analog quantity in a unit time, and the rate of change of the second analog quantity is defined as the change amount of the second analog quantity in a unit time. The controller 131 can also be configured to output the early warning signal when the rate of change of the second analog quantity reaches a third warning threshold. The above configurations further enhance the warning capability of the temperature sensing cable 100, so that the temperature sensing cable 100 can not only respond to the current temperature state, but also provide early warning for the trend of temperature change, thereby playing a key role in fire prevention and early detection.

According to one embodiment of the present disclosure, as shown in FIGS. 1 and 2, the first temperature acquisition circuit 132 may include a first resistor R1 and a second resistor R2 connected in series, and an acquisition node is provided between the first resistor R1 and the second resistor R2 and is utilized to connect the controller 131. The first resistor R1 may be a thermistor, whose resistance value changes according to the temperature. Preferably, the first resistor R1 is a thermistor with a negative temperature coefficient, whose resistance value decreases with the increase of temperature. The controller 131 may be a system integrated chip, which has a power port U1 and a first acquisition port AD1. The first temperature acquisition circuit 132 is coupled between the power port U1 and the ground, and the power port U1 can provide a stable voltage for the first temperature acquisition circuit 132. When the ambient temperature near the first temperature acquisition circuit 132 changes, the resistance value of the first resistor R1 changes, and accordingly, the voltage value at the acquisition node will also change. The first acquisition port AD1 is coupled to the acquisition node in the first temperature acquisition circuit 132, and the controller 131 is configured to obtain the voltage value (the first voltage signal) at the acquisition node via the first acquisition port AD1, and take the first voltage signal as the first analog quantity.

According to an embodiment of the present disclosure, as shown in FIGS. 1 and 2, the temperature-sensing control unit 130 further includes a third resistor R3, a fourth resistor R4, a fifth resistor R5 and a differential circuit 1331, wherein the third resistor R3, the fourth resistor R4, the fifth resistor R5 and the differential circuit 1331 can cooperate with the temperature sensing line 120 to form the second temperature acquisition circuit 133. Specifically, the third resistor R3 is coupled between the upstream end of the first wire 121 and the upstream end of the second wire 122 (in FIGS. 1 and 2, the upstream end is on the left side and the downstream end is on the right side) to close the second temperature acquisition circuit 133. The fourth resistor R4 is coupled between the power port U1 and the downstream end of the first wire 121. The fifth resistor R5 is coupled between the downstream end of the second wire 122 and the ground. The differential circuit 1331 has two input terminals, wherein one input terminal X is coupled to the downstream end of the first wire 121 to acquire the voltage value at the downstream end of the first wire 121, and the other input terminal Y is coupled to the downstream end of the second wire 122 to acquire the voltage value at the downstream end of the second wire 122. The differential circuit 1331 can process the two voltage values (the voltage value at the downstream end of the first wire 121 and the voltage value at the downstream end of the second wire 122) and output the difference between the two voltage values at an output terminal. The power port U1 of the controller 131 can supply a stable voltage for the second temperature acquisition circuit 133. When the ambient temperature near the second temperature acquisition circuit 133 changes, the resistance value of the temperature-sensing material Ra changes, and accordingly, the difference between the voltage value at the downstream end of the first wire 121 and the voltage value at the downstream end of the second wire 122 changes. That is, the voltage value at the output terminal of the differential circuit 1331 changes. The controller 131 can be configured to receive the output signal of the differential circuit 1331 (i.e., the voltage value at the output terminal of the differential circuit 1331) and take it as the second analog quantity. Preferably, the differential circuit 1331 can be integrated in the controller 131, and the controller 131 is configured with two acquisition ports as the two input terminals X and Y of the differential circuit 1331.

According to one embodiment of the present disclosure, as shown in FIGS. 1 and 2, the temperature-sensing control unit 130 may also include a voltage stabilizing capacitor 134, one electrode of the voltage stabilizing capacitor 134 is grounded, and the other electrode thereof is coupled to the power port U1 of the controller 131 (i.e., coupled to the input terminal of the first resistor R1 and the input terminal of the second resistor R4, respectively). With the above configuration, the voltage stabilizing capacitor 134 works in conjunction with the power port U1 of the controller 131 to provide a stable voltage supply for the first temperature acquisition circuit 132 and the second temperature acquisition circuit 133. Its advantage is that it can effectively reduce the noise caused by power fluctuations, thereby significantly reducing the risk of false alarms generated by the controller 131, facilicating improvement of the electromagnetic compatibility of the temperature sensing cable 100, and further ensuring the operating stability of the temperature sensing cable 100 in an environment with electromagnetic interference.

According to one embodiment of the present disclosure, as shown in FIGS. 1 and 2, the controller 131 may include a power-supply port U2 and a data port I/O, wherein the power-supply port U2 can be used to connect an external power supply, and the data port I/O can be used to receive an external signal and can also be used to output a signal to the outside. The power signal multiplexing cable 110 includes a third wire 111 and a fourth wire 112, and the temperature-sensing control unit 130 includes a first filter circuit 135, which is coupled to the third wire 111, the power-supply port U2 and the data port I/O, respectively. The first filter circuit 135 is configured to cooperate with the power signal multiplexing cable 110 to provide a more stable power supply and an amplitude-limited and width-limited signal for the controller 131, so as to effectively suppress the noise and interference on the power line, prevent the excessive signal strength from causing damage or interference to the controller 131, and ensure the definition and accuracy of the signal.

According to an embodiment of the present disclosure, as shown in FIGS. 1 and 2, the first filter circuit 135 may include a sixth resistor R6, a filter capacitor 136 and a noise-reduction discharge device 137, wherein the sixth resistor R6 is connected between the third wire 111 and the power-supply port U2. One electrode of the filter capacitor 136 is grounded, and the other electrode thereof is coupled between the sixth resistor R6 and the power-supply port U2 (i.e., connected to the power-supply port U2). By providing the filter capacitor 136, the high-frequency noise on the power signal multiplexing cable 110 can be effectively filtered out, so as to provide a stable power supply for the controller 131. The noise-reduction discharge device 137 has a built-in spike discharge circuit, which is connected between the third wire 111 and the data port I/O and functions to quickly discharge the spike voltage (i.e., limit the amplitude and width of the signal) without affecting the normal signal transmission, thereby protecting the controller 131 from damage due to the voltage spike.

According to one embodiment of the present disclosure, as shown in FIGS. 1 and 2, the controller 131 has a built-in second filter circuit (not shown in the figures), and the second filter circuit can be coupled to the data port I/O. The interference signal can be filtered out through the second filter circuit to improve the anti-electromagnetic interference performance of the controller 131.

According to one embodiment of the present disclosure, as shown in FIGS. 1 and 2, the temperature-sensing control unit 130 can also include a first diode 138. The first diode 138 is connected between the third wire 111 and the first filter circuit 135. The first diode 138 is configured to allow the current to flow from the third wire 111 to the first filter circuit 135. In addition, the controller 131 also has a power-ground interface U3, which is grounded and connected to the fourth wire 112 via a second diode 139, and the second diode 139 is configured to not allow the current to flow from the fourth wire 112 to the power-ground interface U3.

According to one embodiment of the present disclosure, as shown in FIG. 3, the temperature sensing cable 100 further includes an insulating layer 140, the power signal multiplexing cable 110 and the temperature sensing lines 120 are embedded in the insulating layer 140, a plurality of mounting holes 150 are arranged at an interval on the insulating layer 140, and the temperature-sensing control units 130 are arranged in the corresponding mounting holes 150. An insulating protective layer 160 is sleeved on outside of the insulating layer 140, and the insulating protective layer 160 is arranged along the entire length of the temperature sensing cable 100. The above arrangement can greatly improve the moisture-proof performance of the temperature sensing cable 100 and reduce the possibility of false alarms of the temperature sensing cable 100 in a humid environment.

Compared with the prior art, the embodiment of the present disclosure provides a temperature sensing cable 100 with good anti-electromagnetic interference performance and anti-humidity performance. The controller 131 in the temperature-sensing control unit 130 can sense the change in the temperature nearby through the first temperature acquisition circuit 132 and the second temperature acquisition circuit 133, and output an early warning signal to perform a high temperature warning (or a fire warning), which is conducive to quickly and accurately locating the high temperature point (or the firing point).

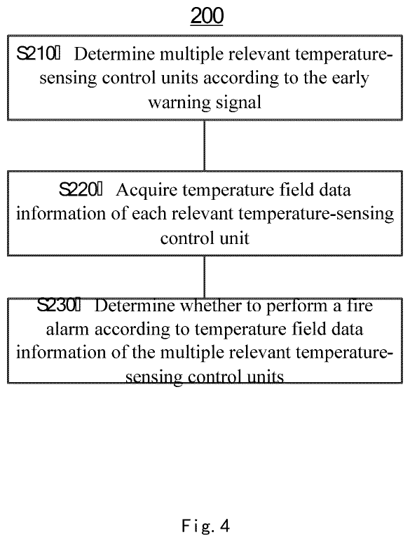

FIG. 4 shows a flow chart of a fire alarm method 200 according to an embodiment of the present disclosure. The fire alarm method 200 can be implemented based on the temperature sensing cable 100 as described above. As shown in FIG. 4, the fire alarm method 200 includes the following steps, which are described in detail below.

In step S210, multiple relevant temperature-sensing control units are determined according to the early warning signal.

In a specific implementation, when the early warning signal is received, the source of the early warning signal can be traced to determine a temperature-sensing control unit that sends out the early warning signal. For example, the early warning signal generally contains the address information of the temperature-sensing control unit (controller) that sends out the early warning signal. Therefore, the temperature-sensing control unit that sends out the early warning signal can be accurately determined through the address information in the early warning signal. After determining the temperature-sensing control unit that sends out the early warning signal, the temperature-sensing control unit and other temperature-sensing control units within a certain range around it can be taken as relevant temperature-sensing control units. Preferably, with the temperature-sensing control unit as the center, the temperature-sensing control unit and other temperature-sensing control units within a certain range upstream and downstream of it are taken as relevant temperature-sensing control units. For example, there are n relevant temperature-sensing control units, and the n relevant temperature-sensing control units are ordered in sequence from the upstream to the downstream of the temperature sensing cable with the serial numbers of 1, 2, 3, . . . , n. It should be noted that the number of relevant temperature-sensing control units should be determined according to the layout of the temperature sensing cable and the actual application scenarios. The present disclosure does not make a rigid provision for the specific setting of this number to adapt to different application requirements and environmental conditions.

In step S220, temperature field data information of each relevant temperature-sensing control unit is acquired, wherein the temperature field data information includes a first analog quantity, a rate of change of the first analog quantity, a second analog quantity, and a rate of change of the second analog quantity.

In a specific implementation, a query instruction can be sent to multiple relevant temperature-sensing control units. Specifically, a specific query instruction can be sent to each relevant temperature-sensing control unit in sequence and separately. The query instruction is only valid for the corresponding relevant temperature-sensing control unit. After the relevant temperature-sensing control unit receives the query instruction related to it, the relevant temperature-sensing control unit feeds back the temperature field data information obtained by it, and other temperature-sensing control units do not respond to the query instruction. In some embodiments, a specific query instruction may also be sent to these relevant temperature-sensing control units, the query instruction is only valid for these relevant temperature-sensing control units, and other temperature-sensing control units do not respond to the query instruction.

After collecting temperature field data information of all relevant temperature-sensing control units, a vector group may be established with these temperature field data information, as shown in Table 1:

| | Temperature field data information | | | |
|---|---|---|---|---|
| Relevant | | Rate of | | Rate of |
| temperature | First | change of the | Second | change of the |
| sensing unit | analog | first analog | analog | second analog |
| (serial number) | quantity | quantity | quantity | quantity |
| 1 | M₁R₁ | M₁R₁/T | M₁Rₐ | M₁Rₐ/T |
| 2 | M₂R₁ | M₂R₁/T | M₂Rₐ | M₂Rₐ/T |
| 3 | M₂R₁ | M₃R₁/T | M₃Rₐ | M₃Rₐ/T |
| . . . | . . . | . . . | . . . | . . . |
| N | MₙR₁ | MₙR₁/T | M₄Rₐ | M₄Rₐ/T |

In step S230, whether to perform a fire alarm is determined according to temperature field data information of multiple relevant temperature-sensing control units.

In a specific implementation, the first factor can be determined according to the first analog quantities of the multiple relevant temperature-sensing control units. Specifically, the first factor can be denoted as A,

$$A = {\sum }_{i = 2}^{n} \vert ( {M}_{i} {R}_{1} - {M}_{i - 1} {R}_{1} ) \vert ,$$

where n is the number of the relevant temperature-sensing control units, MᵢR₁ is the first analog quantity of a relevant temperature-sensing control unit with a serial number i, and Mᵢ₋₁R₁ is the first analog quantity of a relevant temperature-sensing control unit with a serial number i−1.

The second factor can be determined according to the rates of change of the first analog quantities of the multiple relevant temperature-sensing control units. The second factor is the number of ones exceeding a preset threshold among the rates of change of the first analog quantities of the relevant temperature-sensing control units. The second factor can be denoted as B. Specifically, M₁R₁/T, M₂R₁/T, M₁R₃/T . . . MₙR₁/T can be compared with the preset threshold in turn, and the number B of ones exceeding the preset threshold among M₁R₁/T, M₂R₁/T, M₁R₃/T . . . MₙR₁/T can be recorded (counted).

The third factor can be determined based on the second analog quantities of the multiple relevant temperature-sensing control units. Specifically, the third factor can be denoted as C,

$$C = {\sum }_{i = 2}^{n} \vert ( {M}_{i} {R}_{a} - {M}_{i - 1} {R}_{a} ) \vert / {M}_{n} ,$$

where MᵢRₐ is the second analog quantity of a relevant temperature-sensing control unit with a serial number i, Mᵢ₋₁Rₐ is the second analog quantity of a relevant temperature-sensing control unit with a serial number i−1, and Mₙ is an environmental reference value.

The fourth factor can be determined based on the rates of change of the second analog quantities of the multiple relevant temperature-sensing control units. Specifically, the fourth factor can be denoted as D,

$$D = {\sum }_{i = 1}^{n} {M}_{i} {R}_{a} / T ,$$

where MᵢRₐ/T is the rate of change of the second analog quantity of a relevant temperature-sensing control unit with a serial number i.

Weighted fusion may be performed on the first factor, the second factor, the third factor and the fourth factor according to a preset weight coefficient K₁ of the first factor, a preset weight coefficient K₂ of the second factor, a preset weight coefficient K₃ of the third factor and a preset weight coefficient K₄ of the fourth factor, to obtain the fifth factor. Specifically, the fifth factor is denoted as Q, Q=K₁A+K₂B+K₃C+K₄D.

The fifth factor can be compared with a preset alarm threshold. If the fifth factor is greater than the alarm threshold, a fire alarm is performed, and otherwise no fire alarm is performed.

Compared with the prior art, the embodiment of the present disclosure provides a fire alarm method 200 based on a temperature sensing cable, which can reduce false alarms by making a comprehensive judgment on the temperature field data information of multiple relevant temperature-sensing control units. Specifically, by comprehensively considering the first analog quantities (A) and the second analog quantities (C) of the multiple temperature-sensing control units, the subtle differences in temperature changes can be captured more precisely, thereby improving the accuracy of the warning system. By comprehensively considering the rates of change (B and D) of the multiple temperature-sensing control units, it is helpful to distinguish between slow environmental changes and rapid abnormal changes, such as the rapid temperature rise when a fire occurs. By introducing weight coefficients (K1, K2, K3, K4) to perform weighted fusion on different factors, the fifth factor can adjust the importance of each factor according to the needs of the actual application scenarios, and at the same time, the fifth factor can more comprehensively reflect the fire risk, thereby improving the reliability of the fire alarm.

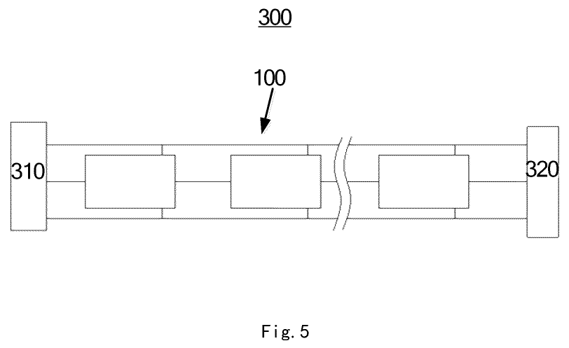

FIG. 5 shows a schematic diagram of a fire alarm system 300 according to an embodiment of the present disclosure, which will be described in detail below in conjunction with FIG. 5.

As shown in FIG. 5, the fire alarm system 300 includes a temperature sensing cable 100, a terminal box 320 and a signal processing unit 310, wherein the signal processing unit 310 is connected to the front end of the temperature sensing cable 100, and the terminal box 320 is connected to the tail end of the temperature sensing cable 100. The terminal box 320 can ensure the normal operation of the temperature-sensing control unit at the tail end of the temperature sensing cable, and ensure the smoothness of the data link by sending a heartbeat signal. The signal processing unit 310 is configured to determine multiple relevant temperature-sensing control units according to the early warning signal, acquire temperature field data information of each relevant temperature-sensing control unit, and determine whether to perform a fire alarm according to temperature field data information of the multiple relevant temperature-sensing control units, wherein the temperature field data information includes a first analog quantity, a rate of change of the first analog quantity, a second analog quantity and a rate of change of the second analog quantity.

According to one embodiment of the present disclosure, as shown in FIG. 5, the signal processing unit 310 can be configured to: determine a temperature-sensing control unit that sends out the early warning signal, according to the early warning signal; and take the temperature-sensing control unit that sends out the early warning signal and multiple temperature-sensing control units in its vicinity as the relevant temperature-sensing control units.

According to an embodiment of the present disclosure, as shown in FIG. 5, the signal processing unit 310 is configured to: determine the first factor according to the first analog quantities of the multiple relevant temperature-sensing control units; determine the second factor according to the rates of change of the first analog quantities of the multiple relevant temperature-sensing control units; determine the third factor according to the second analog quantities of the multiple relevant temperature-sensing control units; determine the fourth factor according to the rates of change of the second analog quantities of the multiple relevant temperature-sensing control units; and perform weighted fusion on the first factor, the second factor, the third factor and the fourth factor according to the preset weight coefficient of the first factor, the preset weight coefficient of the second factor, the preset weight coefficient of the third factor and the preset weight coefficient of the fourth factor, to obtain the fifth factor; if the fifth factor is greater than an alarm threshold, perform a fire alarm, otherwise, perform no fire alarm.

According to one embodiment of the present disclosure, as shown in FIG. 5, the signal processing unit 310 is configured to: determine the first factor A according to the following formula:

$$A = {\sum }_{i = 2}^{n} \vert ( {M}_{i} {R}_{1} - {M}_{i - 1} {R}_{1} ) \vert ,$$

wherein n is the number of the relevant temperature-sensing control units, MᵢR₁ is the first analog quantity of the i-th relevant temperature-sensing control unit among the multiple relevant temperature-sensing control units, and Mᵢ₋₁R₁ is the first analog quantity of the (i−1)th relevant temperature-sensing control unit among the multiple relevant temperature-sensing control units.

According to one embodiment of the present disclosure, as shown in FIG. 5, the second factor is the number of ones exceeding a preset threshold among the rates of change of the first analog quantities of the relevant temperature-sensing control units.

According to one embodiment of the present disclosure, as shown in FIG. 5, the signal processing unit 310 is configured to: determine the third factor C according to the following formula:

$$C = {\sum }_{i = 2}^{n} \vert ( {M}_{i} {R}_{2} - {M}_{i - 1} {R}_{2} ) \vert / {M}_{n} ,$$

wherein n is the number of the relevant temperature-sensing control units, MᵢR₂ is the second analog quantity of the i-th relevant temperature-sensing control unit among the multiple relevant temperature-sensing control units, Mᵢ₋₁R₂ is the second analog quantity of the (i−1)th relevant temperature-sensing control unit among the multiple relevant temperature-sensing control units, and Mₙ is the environmental reference value.

According to one embodiment of the present disclosure, as shown in FIG. 5, the signal processing unit 310 is configured to: determine the fourth factor D according to the following formula:

$$D = {\sum }_{i = 1}^{n} {M}_{i} {R}_{a} / T ,$$

wherein n is the number of the relevant temperature-sensing control units, and MᵢRₐ/T is the rate of change of the second analog quantity of the i-th relevant temperature-sensing control unit among the multiple relevant temperature-sensing control units.

Compared with the prior art, the embodiment of the present disclosure also provides a fire alarm system 300, which can perform a comprehensive judgment on the temperature field data information of the multiple relevant temperature-sensing control units, which is conducive to reducing false alarms, especially false alarms caused by factors such as electromagnetic interference, humid environment, construction extrusion, local rapid temperature rise.

Finally, it should be noted that the above are only preferred embodiments of the present disclosure and are not intended to limit the present disclosure. Although the present disclosure is described in detail with reference to the aforementioned embodiments, it is still possible for those skilled in the art to modify the technical solutions recorded in the aforementioned embodiments, or to replace some of the technical features therein with equivalents. Any modifications, equivalent replacements, improvements and the like made within the spirit and principles of the present disclosure shall be encompassed in the protection scope of the present disclosure.

What is claimed is:

1. A temperature sensing cable, comprising:
a power signal multiplexing cable;
a plurality of temperature sensing lines arranged at an interval along a length direction of the power signal multiplexing cable, the temperature sensing line comprising a first wire, a second wire and a temperature-sensing material, the temperature-sensing material being connected between the first wire and the second wire, the temperature-sensing material being a conductor, and a resistance value of the temperature-sensing material varying with a temperature; and
a plurality of temperature-sensing control units, the temperature-sensing control unit comprising a controller and a first temperature acquisition circuit, the plurality of temperature-sensing control units each being electrically connected between adjacent temperature sensing lines, and adjacent temperature-sensing control units and a temperature sensing line between the adjacent temperature-sensing control units forming a second temperature acquisition circuit, wherein the controller is coupled to the power signal multiplexing cable, the first temperature acquisition circuit and the second temperature acquisition circuit, respectively, the controller is configured to receive and/or send a signal via the power signal multiplexing cable, and the controller is configured to output an early warning signal according to a first analog quantity of the first temperature acquisition circuit and/or a second analog quantity of the second temperature acquisition circuit, and wherein both the first analog quantity and the second analog quantity vary with the temperature.

2. The temperature sensing cable according to claim 1, wherein the controller is configured to:
output the early warning signal when the first analog quantity reaches a first warning threshold and the second analog quantity is in a first warning interval; and/or
output the early warning signal when a rate of change of the first analog quantity reaches a second warning threshold and a rate of change of the second analog quantity is in a second warning interval; and/or
output the early warning signal when the rate of change of the second analog quantity reaches a third warning threshold.

3. The temperature sensing cable according to claim 1, wherein the first temperature acquisition circuit comprises a first resistor and a second resistor connected in series, and wherein the first resistor is a thermistor, and an acquisition node is provided between the first resistor and the second resistor; and
the controller comprises a power port and a first acquisition port, wherein the first temperature acquisition circuit is coupled between the power port and a ground, the first acquisition port is coupled to the acquisition node, and the controller is configured to acquire a first voltage signal via the first acquisition port and take the first voltage signal as the first analog quantity.

4. The temperature sensing cable according to claim 3, wherein the temperature-sensing control unit further comprises a third resistor, a fourth resistor, a fifth resistor and a differential circuit, and wherein the third resistor is coupled between an upstream end of the first wire and an upstream end of the second wire, the fourth resistor is coupled between the power port and a downstream end of the first wire, the fifth resistor is coupled between a downstream end of the second wire and the ground, and the differential circuit has two input terminals, one of which is coupled to the downstream end of the first wire and the other of which is coupled to the downstream end of the second wire; and
the controller is configured to receive an output signal of the differential circuit and take it as the second analog quantity,
wherein the differential circuit is integrated in the controller.

5. The temperature sensing cable according to claim 3, wherein the temperature-sensing control unit further comprises a voltage-stabilizing capacitor, one electrode of which is grounded and the other electrode of which is coupled to the power port.

6. The temperature sensing cable according to claim 1, wherein the power signal multiplexing cable comprises a third wire and a fourth wire;
the controller comprises a power-supply port and a data port; and
the temperature-sensing control unit comprises a first filter circuit, which is coupled to the third wire, the power-supply port and the data port, respectively, and the first filter circuit is configured to cooperate with the power signal multiplexing cable to provide a stable power supply and a signal that has been limited in amplitude and width, for the controller.

7. The temperature sensing cable according to claim 6, wherein the first filter circuit comprises a sixth resistor, a filter capacitor and a noise-reduction discharge device, wherein the sixth resistor is connected between the third wire and the power-supply port; one electrode of the filter capacitor is grounded, and the other electrode of the filter capacitor is coupled between the sixth resistor and the power-supply port; and the noise-reduction discharge device has a built-in spike discharge circuit, and is connected between the third wire and the data port,
wherein the temperature-sensing control unit further comprises a first diode, which is connected between the third wire and the first filter circuit and is configured to allow a current to flow from the third wire to the first filter circuit,
wherein the controller has a built-in second filter circuit, which is coupled to the data port and is configured to filter out an interference signal.

8. The temperature sensing cable according to claim 1, wherein the temperature sensing cable further comprises an insulating layer, the power signal multiplexing cable and the temperature sensing lines are embedded in the insulating layer, a plurality of mounting holes are provided on the insulating layer, and the temperature-sensing control units are provided in the mounting holes; and an insulating protective layer is sleeved on outside of the insulating layer, and is arranged along an entire length of the temperature sensing cable.

9. A fire alarm method, based on the temperature sensing cable, the temperature sensing cable, comprising: a power signal multiplexing cable; a plurality of temperature sensing lines arranged at an interval along a length direction of the power signal multiplexing cable, the temperature sensing line comprising a first wire, a second wire and a temperature-sensing material, the temperature-sensing material being connected between the first wire and the second wire, the temperature-sensing material being a conductor, and a resistance value of the temperature-sensing material varying with a temperature; and a plurality of temperature-sensing control units, the temperature-sensing control unit comprising a controller and a first temperature acquisition circuit, the plurality of temperature-sensing control units each being electrically connected between adjacent temperature sensing lines, and adjacent temperature-sensing control units and a temperature sensing line between the adjacent temperature-sensing control units forming a second temperature acquisition circuit, wherein the controller is coupled to the power signal multiplexing cable, the first temperature acquisition circuit and the second temperature acquisition circuit, respectively, the controller is configured to receive and/or send a signal via the power signal multiplexing cable, and the controller is configured to output an early warning signal according to a first analog quantity of the first temperature acquisition circuit and/or a second analog quantity of the second temperature acquisition circuit, and wherein both the first analog quantity and the second analog quantity vary with the temperature, the fire alarm method comprising:
determining a plurality of relevant temperature-sensing control units according to the early warning signal;
acquiring temperature field data information of each of the relevant temperature-sensing control units, the temperature field data information comprising a first analog quantity, a rate of change of the first analog quantity, a second analog quantity, and a rate of change of the second analog quantity; and
determining whether to perform a fire alarm according to the temperature field data information of the plurality of relevant temperature-sensing control units.

10. The fire alarm method according to claim 9, wherein the determining a plurality of relevant temperature-sensing control units according to the early warning signal comprises:
determining a temperature-sensing control unit that sends out the early warning signal, according to the early warning signal; and
taking the temperature-sensing control unit that sends out the early warning signal and a plurality of temperature-sensing control units in its vicinity as the relevant temperature-sensing control units.

11. The fire alarm method according to claim 9, wherein the determining whether to perform a fire alarm according to the temperature field data information of the plurality of relevant temperature-sensing control units comprises:
determining a first factor according to the first analog quantities of the plurality of relevant temperature-sensing control units;
determining a second factor according to the rates of change of the first analog quantities of the plurality of relevant temperature-sensing control units;
determining a third factor according to the second analog quantities of the plurality of relevant temperature-sensing control units;
determining a fourth factor according to the rates of change of the second analog quantities of the plurality of relevant temperature-sensing control units;
performing weighted fusion on the first factor, the second factor, the third factor and the fourth factor according to a preset weight coefficient of the first factor, a preset weight coefficient of the second factor, a preset weight coefficient of the third factor and a preset weight coefficient of the fourth factor, to obtain a fifth factor;
if the fifth factor is greater than an alarm threshold, performing a fire alarm; and
otherwise, performing no fire alarm.

12. The fire alarm method according to claim 11, wherein the first factor A is determined according to the following formula:
$$A = {\sum }_{i = 2}^{n} \vert ( {M}_{i} {R}_{1} - {M}_{i - 1} {R}_{1} ) \vert ;$$
where n is a number of the relevant temperature-sensing control units, MᵢR₁ is the first analog quantity of an i-th relevant temperature-sensing control unit among the plurality of relevant temperature-sensing control units, and Mᵢ₋₁R₁ is the first analog quantity of an (i−1)th relevant temperature-sensing control unit among the plurality of relevant temperature-sensing control units,
wherein the second factor is a number of ones exceeding a preset threshold among the rates of change of the first analog quantities of the relevant temperature-sensing control units.

13. The fire alarm method according to claim 11, wherein the third factor C is determined according to the following formula:
$$C = {\sum }_{i = 2}^{n} \vert ( {M}_{i} {R}_{a} - {M}_{i - 1} {R}_{a} ) \vert / {M}_{n} ;$$
where n is a number of the relevant temperature-sensing control units, MᵢRₐ is the second analog quantity of an i-th relevant temperature-sensing control unit among the plurality of relevant temperature-sensing control units, Mᵢ₋₁Rₐ is the second analog quantity of an (i−1)th relevant temperature-sensing control unit among the plurality of relevant temperature-sensing control units, and Mₙ is an environmental reference value.

14. The fire alarm method according to claim 11, wherein the fourth factor D is determined according to the following formula:
$$D = {\sum }_{i = 1}^{n} {M}_{i} {R}_{a} / T ;$$
where n is a number of the relevant temperature-sensing control units, and MᵢRₐ/T is the rate of change of the second analog quantity of an i-th relevant temperature-sensing control unit among the plurality of relevant temperature-sensing control units.

15. A fire alarm system, comprising:
a temperature sensing cable, comprising:
a power signal multiplexing cable;
a plurality of temperature sensing lines arranged at an interval along a length direction of the power signal multiplexing cable, the temperature sensing line comprising a first wire, a second wire and a temperature-sensing material, the temperature-sensing material being connected between the first wire and the second wire, the temperature-sensing material being a conductor, and a resistance value of the temperature-sensing material varying with a temperature; and
a plurality of temperature-sensing control units, the temperature-sensing control unit comprising a controller and a first temperature acquisition circuit, the plurality of temperature-sensing control units each being electrically connected between adjacent temperature sensing lines, and adjacent temperature-sensing control units and a temperature sensing line between the adjacent temperature-sensing control units forming a second temperature acquisition circuit, wherein the controller is coupled to the power signal multiplexing cable, the first temperature acquisition circuit and the second temperature acquisition circuit, respectively, the controller is configured to receive and/or send a signal via the power signal multiplexing cable, and the controller is configured to output an early warning signal according to a first analog quantity of the first temperature acquisition circuit and/or a second analog quantity of the second temperature acquisition circuit, and wherein both the first analog quantity and the second analog quantity vary with the temperature
a terminal box connected to a tail end of the temperature sensing cable; and
a signal processing unit connected to a front end of the temperature sensing cable and configured to:
determine a plurality of relevant temperature-sensing control units according to the early warning signal;
acquire temperature field data information of each of the relevant temperature-sensing control units, the temperature field data information comprising a first analog quantity, a rate of change of the first analog quantity, a second analog quantity, and a rate of change of the second analog quantity; and
determine whether to perform a fire alarm according to the temperature field data information of the plurality of relevant temperature-sensing control units.

16. The fire alarm system according to claim 15, wherein the signal processing unit is configured to:
determine a temperature-sensing control unit that sends out the early warning signal, according to the early warning signal; and
take the temperature-sensing control unit that sends out the early warning signal and a plurality of temperature-sensing control units in its vicinity as the relevant temperature-sensing control units.

17. The fire alarm system according to claim 15, wherein the signal processing unit is configured to:
determine a first factor according to the first analog quantities of the plurality of relevant temperature-sensing control units;
determine a second factor according to the rates of change of the first analog quantities of the plurality of relevant temperature-sensing control units;
determine a third factor according to the second analog quantities of the plurality of relevant temperature-sensing control units;
determine a fourth factor according to the rates of change of the second analog quantities of the plurality of relevant temperature-sensing control units;
perform weighted fusion on the first factor, the second factor, the third factor and the fourth factor according to a preset weight coefficient of the first factor, a preset weight coefficient of the second factor, a preset weight coefficient of the third factor and a preset weight coefficient of the fourth factor, to obtain a fifth factor;
if the fifth factor is greater than an alarm threshold, perform a fire alarm; and
otherwise, perform no fire alarm.

18. The fire alarm system according to claim 17, wherein the signal processing unit is configured to: determine the first factor A according to the following formula:
$$A = {\sum }_{i = 2}^{n} \vert ( {M}_{i} {R}_{1} - {M}_{i - 1} {R}_{1} ) \vert ;$$
where n is a number of the relevant temperature-sensing control units, MᵢR₁ is the first analog quantity of an i-th relevant temperature-sensing control unit among the plurality of relevant temperature-sensing control units, and Mᵢ₋₁R₁ is the first analog quantity of an (i−1)th relevant temperature-sensing control unit among the plurality of relevant temperature-sensing control units,
wherein the second factor is a number of ones exceeding a preset threshold among the rates of change of the first analog quantities of the relevant temperature-sensing control units.

19. The fire alarm system according to claim 17, wherein the signal processing unit is configured to determine the third factor C according to the following formula:
$$C = {\sum }_{i = 2}^{n} \vert ( {M}_{i} {R}_{a} - {M}_{i - 1} {R}_{a} ) \vert / {M}_{n} ;$$
where n is a number of the relevant temperature-sensing control units, MᵢRₐ is the second analog quantity of an i-th relevant temperature-sensing control unit among the plurality of relevant temperature-sensing control units, Mᵢ₋₁Rₐ is the second analog quantity of an (i−1)th relevant temperature-sensing control unit among the plurality of relevant temperature-sensing control units, and Mₙ is an environmental reference value.

20. The fire alarm system according to claim 17, wherein the signal processing unit is configured to determine the fourth factor D according to the following formula:
$$D = {\sum }_{i = 1}^{n} {M}_{i} {R}_{a} / T ;$$
where n is a number of the relevant temperature-sensing control units, and MᵢRₐ/T is the rate of change of the second analog quantity of an i-th relevant temperature-sensing control unit among the plurality of relevant temperature-sensing control units.
